(19) United States
(12) Patent Application Publication
(10) Pub. No.: US 2006/0015878 A1
(43) Pub. Date: Jan. 19, 2006

(54) Command entry portal navigation

(76) Inventor: Gerd M. Ritter, Heidelberg (DE)

Correspondence Address: FISH & RICHARDSON, P.C., PO BOX 1022, MINNEAPOLIS, MN, 55440-1022, US

(21) Appl. No.: 10/890,778

(22) Filed: Jul. 14, 2004

(51) Int. Cl. G06F 13/00

(52) U.S. Cl. 719/310

(57) ABSTRACT

Methods and computer program products that enable command entry portal navigation (CEPN) permit a portal user to navigate directly to a desired tile of information by entering a textual navigation command (TNC) into an input field associated with the portal. The TNC may include a command directing the computer system to interpret the TNC to determine which of a plurality of application programs is to be accessed and displayed on the portal. The TNC may also allow the user to directly perform some action within the target application by entering a single textual command. In some embodiments, the TNC may include additional commands that may be interpreted according to predefined grammar rules. In response to the TNC, the computer system may send information generated by the access to be displayed in a tile within the portal frame.

### TECHNICAL FIELD

This invention relates to accessing information using a portal.

### BACKGROUND

Generally, a portal provides a computer user with a starting point for accessing a vast array of resources and services. Portals may typically contain news, e-mail services, search engines, online shopping, chat rooms, discussion boards, as well as links to other web sites. The links and web pages designed for portals available on the Internet tend to reflect generic topics that are searched by users on the Internet.

The term “corporate portals” may typically refer to portals that run on intranets to provide proprietary information to employees, suppliers, and business partners. Corporate portals may allow users to locate and share knowledge, participate in business processes, and provide collaboration services. Corporate portals generally provide search engines for identifying and working on internal materials or business documents, as well as access to websites over the Internet. Typically, the links and pages provided by corporate portals fulfill the varied needs of users in an organization.

Some computing systems that use GUIs allow a user to interact with a number of application programs through a portal. In general, portals provide a framework for displaying sets of predefined pages of content. Portals may be configured for use by, for example, a project team, a department, a branch office, or an entire company. Some portals may be used to display view sets of information, which may be referred to herein as tiles. As such, information generated when an application program is accessed may be displayed in tiles on the portal. The portal may allow a user to navigate to a number of tiles associated with various application programs by, for example, clicking links displayed within the portal.

In some examples, a portal may be operated by a client on a stand-alone computer, such as a PC. In other examples, portals may deliver resources and web services to users through a software application known as a browser. The browser may act as an interface for sending web page display requests to the portal and for displaying resultant web pages received from the portal. Resultant web pages may be displayed by the portal, which follows the navigation defined for the resultant web page.

Within a portal, the pages, viewsets, or tiles may be hierarchically arranged such that navigation to a desired page, viewset, or tile, may require a series of sequential input actions. For example, navigating from an appointment calendar tile to a business partner record tile may require the user to select several links, and may involve typing the name of the business partner. For some experienced users, this navigation process may cause delays and limit productivity. For a networked computing system, such a sequential navigation process may increase the computational and data traffic burdens on the network and servers that process each step. As a result, user efficiency, user productivity, and network performance may be limited by the process of navigating to desired pages using a portal.

In a portal, a user may make input actions to cause the computing system to navigate to or to access information. For example, a user may make input actions to cause an application program to start running, to print a document, to enter a meeting into an electronic appointment book, to send an e-mail, to navigate within a portal, to switch between application programs, and the like.

Portal users may enter input actions in various ways. For example, a user may provide input to a computer by using, for example, a hand-held pointing device (i.e. computer mouse) to select certain selectable objects displayed on a computer screen. The selected object may be, for example, an icon on a desktop, or a hyperlink on a page displayed in a web browser. In a graphical user interface (GUI) environment, a user may typically input a command to start an application, for example, by using a pointing device, such as a computer mouse, to select an icon on a computer desktop or in an electronic folder.

Some software applications are organized to permit a user to access certain features or functions through one or more sub-applications. For software applications that use a graphical user interface (GUI), a typical method of navigating to a sub-application within an application is to use a mouse-pointing device to selectively click on hyperlinks that are displayed on the GUI. Some software application may have many features and sub-applications. Accordingly, a GUI may be organized to display only a portion of all available links to the sub-applications at any a time so as not to overwhelm the user with possible choices. Consequently, a user may use a mouse, for example, to click through several links, menu items, or icons within an application to navigate, for example, from one sub-application in an application program to a sub-application in a different application program. For example, in order to activate a desired target application, the user may click through several links, menu items, or icons in the process of navigating through several levels of GUI display screens.

Another method of navigating to a desired application or sub-application is to provide a list of available applications, commonly referred to as a “favorites” list. A user may navigate directly to a target application or sub-application by selecting a corresponding link from the favorites list. However, in some examples, a favorites list may display only a fraction of all possible sub-applications that may be displayed. Furthermore, the practical limit on the number of items that can be displayed may be determined by available display screen area. Moreover, it may be inefficient for an experienced user to locate and select an item from a list containing numerous items that are not of interest.

### SUMMARY

Methods and computer program products that enable command entry portal navigation (CEPN) permit a portal user to navigate directly to a desired tile of information by entering a textual navigation command (TNC) into an input field associated with the portal. The input field may be associated with the frame of the portal being displayed on a display device. A user may enter the TNC into the input field by, for example, typing on a keyboard coupled to a computer system. The TNC may include a command that, after interpretation, directs the computer system to access one of a plurality of application programs for display on the portal. In response to the TNC, the computer system may send information generated by the access to be displayed in a tile within the portal frame.

The TNC may be received, for example, in a single-line format in an input field associated with a portal. The TNC may allow the user to directly perform some action within the target application by entering a single textual command. In some embodiments, the TNC may include additional commands that may be interpreted according to predefined grammar rules. One such command may include an action command that may be interpreted to identify an action to be performed. Performing the action may generate information that the computer system may include in the information sent for display in the portal.

Some embodiments may provide one or more advantages. For example, a user may use command entry portal navigation (CEPN) to navigate directly to a target application in a portal in less time and in only a single step. CEPN may reduce the number of user input actions required to navigate to and to start a target application in a portal. As such, CEPN may improve the efficiency and productivity with which a user may access application programs within a portal. Moreover, the ability to incorporate action commands into the textual command may further improve efficiency and productivity gains by reducing the number of user input actions required to perform actions within the target application. Furthermore, reducing the number of “round-trip” data transfers between the client device, the portal server, and the application servers, may reduce the bandwidth consumed by navigation-related data transfers, especially on a networked computer system. This may yield increased available data transfer capacity for an entire networked system. By reducing the computational burden associated with accessing application software through a portal, CEPN may increase available computational capacity for a networked computing system.

The details of one or more embodiments are set forth in the accompanying drawings and the description below. Other features and advantages will be apparent from the description, the drawings, and the claims.

### DESCRIPTION OF DRAWINGS

FIG. 1 is a block diagram of a workplace system capable of using CEPN.

FIG. 2 is a block diagram of computer hardware on which CEPN may be implemented.

FIG. 3 is diagram of an exemplary set of hierarchically related tiles that may be accessed and displayed in a portal.

FIG. 4 is a flowchart for a method of operating a portal server.

FIG. 5 is a flowchart for a method of operating an application server.

FIG. 6 is a flowchart for a method of operating a parsing engine.

FIGS. 7A-7E are tiles that illustrate one method of operating a portal to access a desired tile associated with an application program.

FIGS. 8A-8B are tiles that illustrate use of CEPN to access the desired tile using a single TNC.

Like reference symbols in the various drawings indicate like elements.

### DETAILED DESCRIPTION OF ILLUSTRATIVE EMBODIMENTS

Command entry portal navigation (CEPN) may include activating a target application within a portal. As used herein, accessing a target application may refer both to navigating to the target application and to starting the target application. CEPN may also include performing actions within the target application. Activating the target application and performing actions within the target application program may be performed in response to user-input of a single textual navigation command (TNC) in an input field associated with the portal. The text of the TNC may include a combination of one or more words, abbreviations, symbols, or numbers that are entered in a single phrase or sentence using a text input device, such as a keyboard.

Some operational aspects of CEPN may be illustrated by the following example. A user may input the text of a TNC into an input field being displayed on the frame of a portal. The TNC may include an application command and a first action command. In one example, a portal server may execute programmed instructions to parse the TNC and to interpret the application command portion. According to the result, the portal server may send a signal requesting that the appropriate application server activate the application program corresponding to the application command. The portal server may also send the action command to the application server for interpretation. The application server may execute programmed instructions to interpret the first action command. The application server may execute the instructions for starting the application program, and may then execute the application program instructions corresponding to the action command. Finally, the application server may send displayable information associated with accessing the application program to the portal server. The portal server may then integrate the application program display information into the portal display information, and send the integrated information for display on the client device.

Some TNC's may be interpreted by executing instructions on a portal server that may send information to a display device to cause a portal to be displayed. In some examples, the TNC may be further interpreted by executing instructions on an application server. In one embodiment, the portal server may perform an initial interpretation of at least a portion of the TNC. Generally, the portal server may interpret the portal navigation portion of the TNC, i.e. the portal server may determine which application program to the TNC is directed to. Subsequently, other (non-portal navigation) portions of the TNC may be interpreted by the application program. In one embodiment, portions of the TNC that are not interpreted by the portal server may be interpreted and processed by the application server.

For example, a complete interpretation of a TNC containing “Oppt Miller” may be (1) to display tiles associated with the “opportunity management” application program in a portal, and (2) to display all records with opportunities of business partner “Miller.” According to the foregoing embodiment, (1) the portal server initially interprets the TNC to determine that the TNC is directed to accessing (also referred to as launching) the application program “Oppmanagement.” The portal server may then transfer the remainder of the TNC to an application server configured to launch the application program. Next, the application server in this example may interpret the remaining parameters of the TNC by searching for all opportunities with Miller as a business partner. Both interpretations may be performed according to predefined grammar or syntax rules.

Portals may be configured to display information associated with a number of application programs, such as an electronic appointment scheduler, an electronic contact address book, and an electronic task list, among many other possible examples.

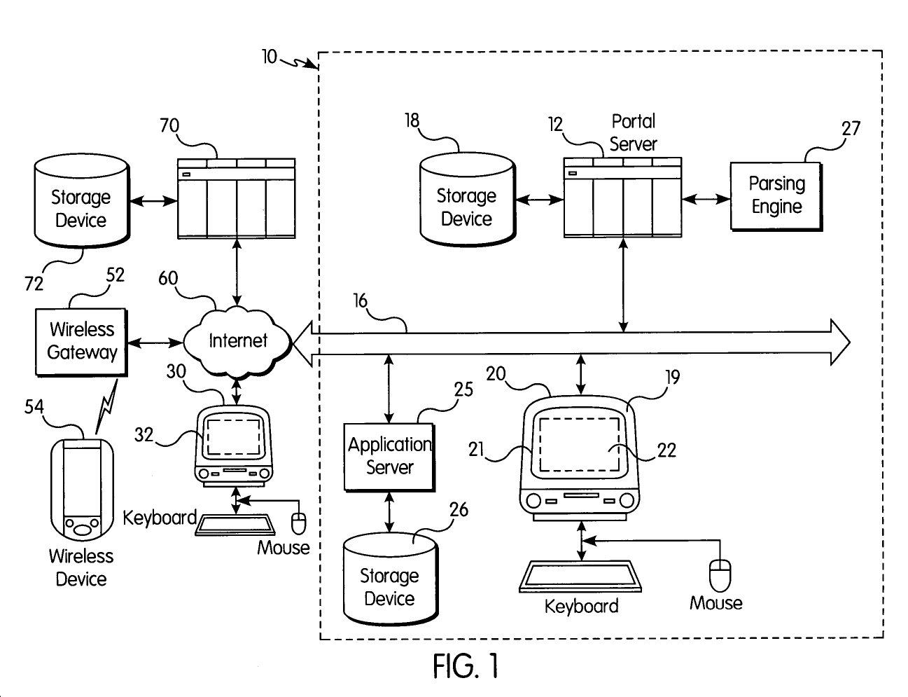

Command entry portal navigation (CEPN) using TNC input may be performed on an exemplary workplace system as illustrated in FIG. 1. The workplace system 10 includes a portal server 12 and a client device 20 coupled to communicate with each other on a network 16. The client device 20 includes a display device 19, which has a display screen with a displayable area 21. A portal 22 occupies a portion of the displayable area 21. A user may interact with the portal 22 by entering information via a keyboard and/or a mouse configured to provide input signals to the client device 20.

The portal computer 12 is coupled to a data storage device 18, which may store resources for generating portal pages that may be displayed within the portal 22. A resource is any tool, application program, file, document, or other item of information to be accessed. In this example, “tools” refers to applications that may be executed on a user device, such as client computer 20, and “information” refers to data that may be displayed as text or images, e.g., on a portal window 22 of the display device 19.

An application server 25 may also be coupled to communicate with the client 20 or the portal server 12 over the network 16. The application server 25 may execute application programs that are stored on a data storage device 26. The application server 25 may also exchange information with the portal server 12 over the link 16. Those tools and/or information may be retrieved by the individual on client 20, and displayed in the portal window 22. In operation, a user may interact with the portal window 22 on client 20 to request access to specific tools and/or information via the portal server 12.

In some embodiments of the workplace system 10, a “portal” may refer to a starting point for a user to gain access to application programs and other information stored on, for example, data storage devices 18 or 26. A portal display component 23 executed on the user device 20 can be used to control the portal 22. In one example, the portal 22 may be implemented as a browser application being executed on a user device that, when initially launched, displays a “home page” window that provides the user with easy access to a collection of various tools and resources.

Workplace system 10 is also coupled to Internet 60 via network 16. Internet 60 is an example of a “wide area network” (WAN), i.e., a network of inter-connected computers that may communicate with one another, for example, transmitting data, messages, and application information to one another. In this example, an external server 70 and an external computer 30 are coupled to Internet 60. External server 70 is coupled to a storage device 72 that is used to store external portal page resource information 82. Therefore, in this implementation, the resources accessible to an individual through the portal 22 may include “internal” and “external” portal page resources.

Portal page resources may include, for example, available service (also called a tool) from an internal or external computer system. For example, a tool may refer to a payroll service, a benefits management service, a billing service, etc. As a further example, an individual whose assigned role includes shipping packages might have access to a courier company's service on Internet 60. The courier company service may allow the individual to execute and interact with an application that allows scheduling pick-up and/or delivery of a package, and may also allow the individual to acquire information about where the package is, package volume shipped, and/or package volume delivered to a customer, etc. If the assigned responsibilities of an individual role include making travel reservations, his or her portal may, for example, have access to a travel service (e.g., an application) provided by a travel management service through Internet 60. The travel service may allow the employee to execute and interact with an application that provides information about prices, travel times, and routes, for example. In response to input selections made by the individual, the travel management service may process and deliver tickets (or confirm for e-ticketing), and may further provide travel summary information for individuals, groups, offices, and the like.

An individual's access to workplace system 10 typically is not limited to using the external computer 30. For example, an individual may use a wireless device 54 coupled to communicate with portal server 12 through a wireless gateway 52 coupled to Internet 60. As another example, an individual may use an external computer 30 coupled to communicate with portal server 12 through Internet 60. In some embodiments, an individual may use a device having Internet access and capable of running a browser application to access application programs within a portal being served by the portal server 12.

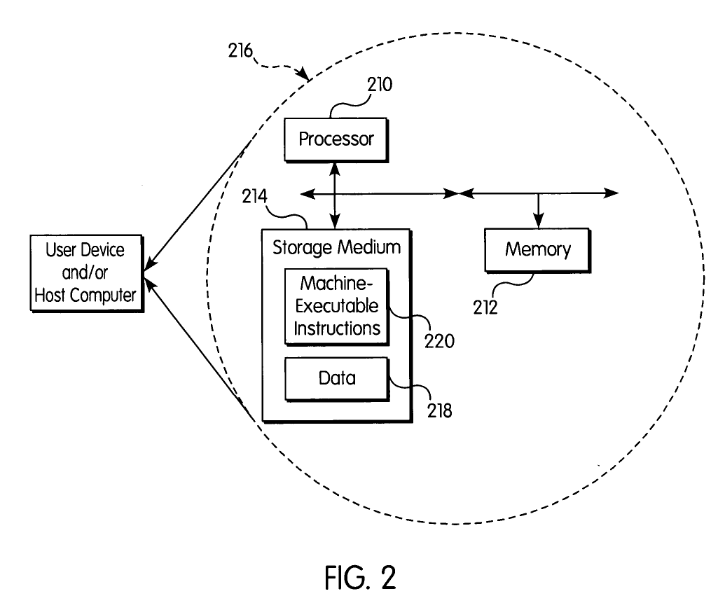

In the above example as shown in FIG. 1, portal pages may be accessed by operating any of client devices 20, 30, and 54 in cooperation with servers 12, 25, and 70. The operation of these devices may each include the elements of a processor-based computing system, as illustrated in FIG. 2. In general, a processor-based computing system may include a processor 210, a memory 212, and a storage medium 214. Storage medium 214 stores data 218 and machine-executable instructions 220. The processor 210 can execute the instructions 220, for example, when the instructions have been loaded into memory 212. When executed by the processor 210, the instructions 220 may cause the computing system to perform operations. The operations may include, for example, aspects of generating displayable information associated with an application program to be sent for display in a portal on a display device. The operations may also include accessing an application program by interpreting received user input commands. Furthermore, some of the computing systems may include an operating system.

Command entry portal navigation need not be limited to use with the hardware and software described above with respect to the exemplary embodiments shown in FIGS. 1-2. CEPN may find applicability in any computing or processing environment and may be implemented in hardware, software, or a combination of the two. They may be implemented in computer programs executed on programmable computers or other machines that each includes: a processor, a storage medium readable by the processor (including volatile and non-volatile memory and/or storage components), at least one input device, and one or more output devices. Program code may be applied to user-input TNC's entered using a text input device (e.g., a keyboard) to access applications to perform actions and to generate information for display.

A portal may be used to display a number of tiles, view sets, or pages. Each page or tile displayed in the portal may include information that may be used by the user. The data for each such page or tile may be stored on, for example, data storage device 18 or other data storage device.

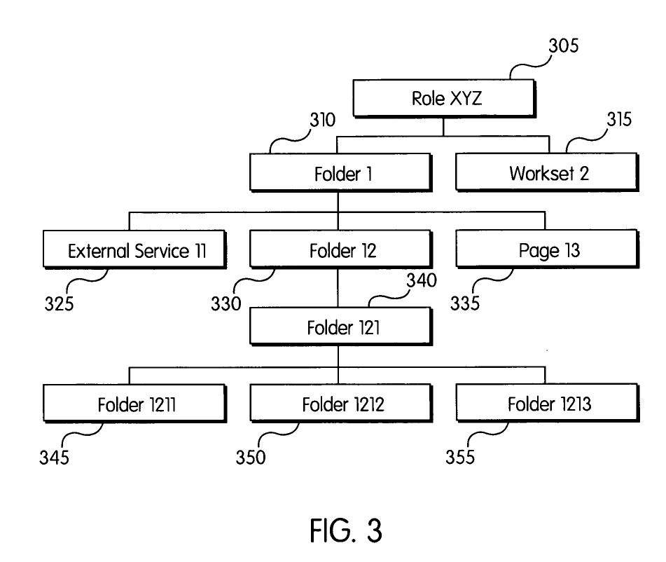

The tiles may be related for purposes of portal navigation according to a hierarchical structure, an example of which is illustrated in FIG. 3. In this exemplary hierarchical structure, the top level of the hierarchy may be referred to as a home page tile 305. The home page tile 305 defines information that is displayed when, for example, a portal is first displayed. The home page tile 305 may include information that is stored on a storage device 18. According to the hierarchy in this example, the user of the portal may navigate from the home page tile 305 to first level navigation tiles. The first level navigation tiles may include, for example, one or more folders, work sets, or pages. According to the predefined hierarchy, navigating to a sub-tile may reveal links to further sub-tiles. In one embodiment, navigating to a particular sub-tile may change the links that may be accessed via a navigation bar. In another embodiment, navigating to a sub-tile may cause an additional navigation bar to be displayed with links to other tiles according to the relationships in the exemplary hierarchy. In some embodiments, a portal may display links to one or more tiles that are not adjacent to the currently displayed tile in the hierarchy. For example, a portal may display a link to navigate directly from any tile in the hierarchy to the home page tile 305.

In FIG. 3, a tile 310 is shown as being in the first level of navigation tiles. In this example, the tile 310 is hierarchically related to tiles on a second level of navigation tiles 325-335. Each of the tiles of information 325-335 may represent various combinations and numbers of displayable tiles, such as external services, folders, and pages, for example. The external service 325, for instance, may include analytics from another provider or from a legacy system.

In this example, the tile 330 is hierarchically related to other displayable tiles. In this example, a user can navigate from tile 330 to a tile 340 in a third level of navigation tiles. In addition, the tile 330 may also be hierarchically related to sub-tiles in a fourth level of navigation tiles, namely tiles 345-355. In other embodiments, multiple tiles may be hierarchically related in parent-child relationships to tiles 345-355.

Conventionally, navigation within the exemplary hierarchy of FIG. 3 may be accomplished in one or more sequential steps. A mouse-pointing device may be used to navigate up or down the hierarchical structure in a series of steps from a presently displayed tile to a desired tile in the hierarchy. For example, from the tile 315 in the first level of the hierarchy, a user may wish to view the page at tile 355. In order to navigate from the tile 315 to the tile 355 in the fourth level of tiles, a user may conventionally navigate up the hierarchical tree to the home page tile 305, and then sequentially down the hierarchical structure to the tile 310, the tile 330, the tile 340, and finally arriving at the tile 355.

In the foregoing example, navigation within the portal from one tile to another was accomplished by performing a series of sequential operations. Typically, the sequential operations involve a user using a mouse-pointing device to click on links displayed in the portal to navigate to the next adjacent tile in the hierarchy. Each such operation may involve a “round trip” from the client 20 to the portal server 12, and further may involve the access of display tile information from a data storage device, such as data storage device 18. With reference to FIG. 1, in some embodiments, each round trip may also include an access of data stored in the data storage device 26 through the application server 25 of FIG. 1. In addition, the network traffic associated with these navigation round trips can contribute significantly to the network load and the computational burden on servers and associated networking equipment in a networked computing system.

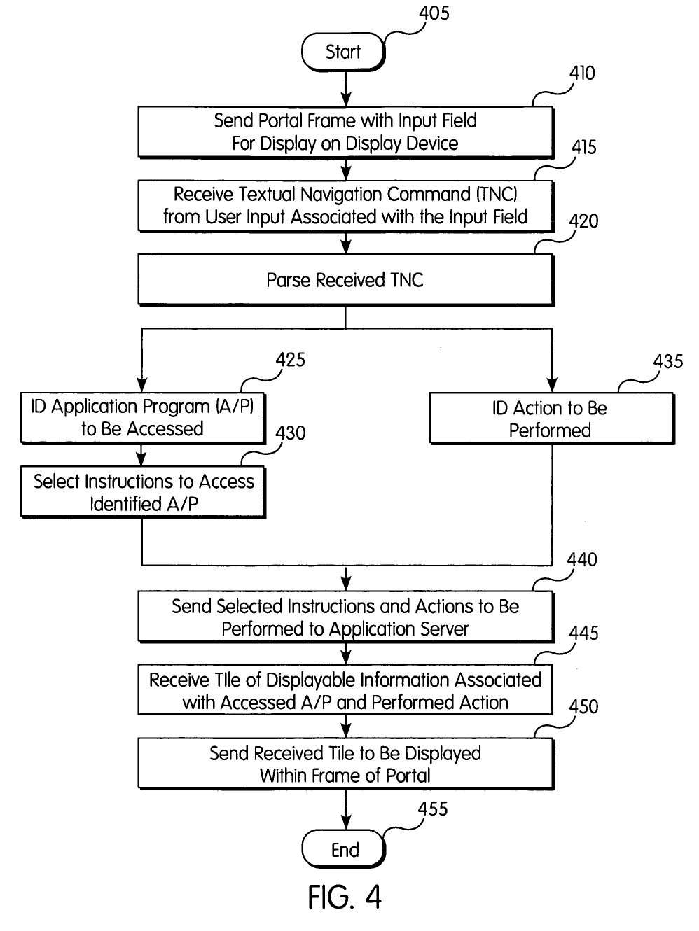

The portal 22 that is being displayed on the client 20 may be used to access one of a number of application programs when the workplace system 10 is operated according to the exemplary methods of FIGS. 4-6. These methods are merely illustrative, and one of ordinary skill in the art may make modifications to achieve the features and advantages of the examples described herein.

An exemplary method, as shown in FIG. 4, may be performed by the portal server 12. Starting at step 405, the portal server 12 sends a portal frame with an input field for display on the display device 19 at step 410. At step 415, the portal server 12 receives a textual navigation command (TNC) from user input that is associated with the input field. For example, the portal 22 may have a frame that comprises a border within which displayable tiles may be displayed. In some embodiments, an input field into which a user may enter the TNC may be displayed on the area associated with the portal frame.

At step 420, the parsing engine 27 parses the received TNC. Upon parsing the TNC, the portal server 12 can identify the application program to be accessed at step 425. The portal server 12 may also select instructions that may be used to access the identified application program at step 430. In addition, upon parsing the received TNC at step 420, the portal server 12 may identify the action to be performed at step 435. In alternative embodiments, step 435 may be performed by another device, such as the application server 25. After completing steps 430-435, the portal server 12 may send the instructions selected at step 430 and the identified actions to be performed at step 435 to the application server 25 at step 440. Then, at step 445, the portal server may wait to receive a tile of displayable information that is associated with the accessed application program and the performed action. At step 450, the portal sends the received tile to be displayed within the frame of the portal 22 on the client 20. The method ends at step 455, and may be repeated upon the user entering a subsequent TNC into the input field of the portal to navigate directly to any tile in the hierarchy.

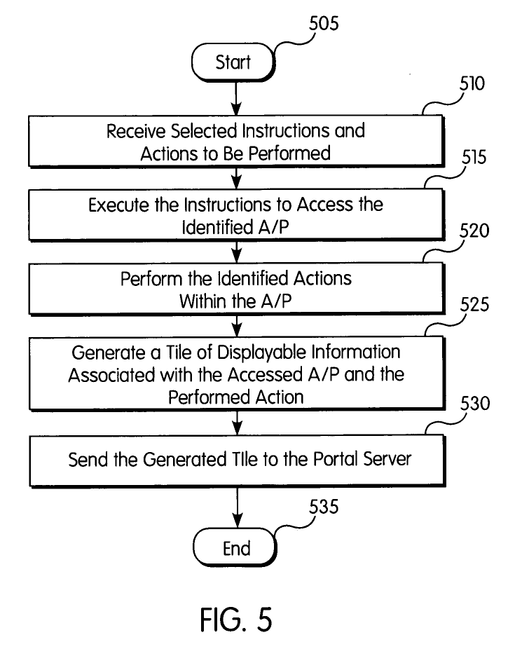

After the portal server 12 performs step 440 and waits for a response at step 445, the application server 25 may perform an exemplary method starting at step 505, as shown in FIG. 5. At step 510, the application server 25 receives the selected instructions and actions to be performed as sent by the portal server 12 at step 440. The application server 25 executes the instructions to access the identified application program at step 515. Upon accessing the identified application program, the application server 25 may perform the identified actions within the application program at step 520. At step 525, the application server 25 generates a tile of displayable information that is associated with the access application program and the performed action. Then, at step 530, the application server 25 sends the generated tile to the portal server, which completes the method at step 535.

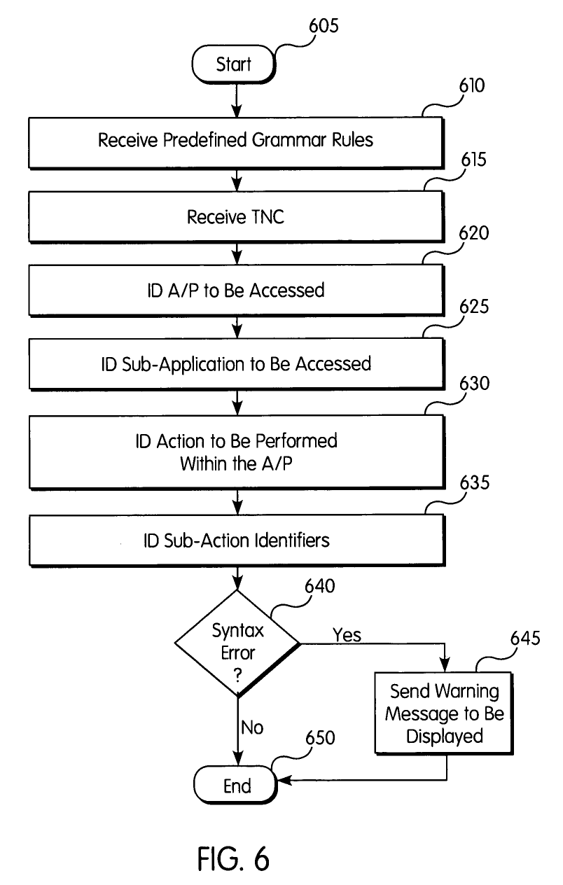

In one embodiment, the parsing engine 27 may parse the received TNC at step 420 according to an exemplary method of FIG. 6. Starting at step 605, the parsing engine 27 may receive a set of predefined grammar rules at step 610. At step 615, the parsing engine may receive the TNC that the user entered into the input field in the portal 22. The parsing engine 27 may identify the application program to be accessed at step 620. If the TNC includes a sub-application identifier, then the parsing engine 27 identifies the sub-application to be accessed at step 625. At step 630, the parsing engine 27 may identify the action to be performed within the application program, which, in some embodiments, corresponds to the step 435. If the TNC includes an action sub-identifier, then the parsing engine 27 can identify any sub-actions that are to be performed. In one embodiment, multiple actions may be identified during the parsing and interpretation process. For example, in response to a TNC “edit opport miller,” the parsing engine may first identify that “Opportunity Management” is the application program to be accessed. The parsing and interpretation may further identify that two actions are to be performed within the application program: (1) open the opportunities in edit mode, and (2) display the records for “Miller.” In another example, the parsing and interpretation process may identify (1) an application object (e.g. BizObject) and (2) one or more action identifiers that determine what to do in the identified application object.

After all the text of the TNC has been parsed by the parsing engine 27 to identify any portions of the TNC that correspond to the set of predefined grammar rules, the parsing engine 27 may determine whether a syntax error has occurred. If a syntax error has occurred, then the parsing engine 27 may cause a message to be displayed on the display device 19 to indicate to the user that the TNC could not be entirely parsed. If any parts of the TNC cannot be interpreted, then they may be ignored in some embodiments. However, if no syntax error was detected at step 640, then the method performed by the parsing engine 27 ends at step 650.

In some embodiments, the foregoing method may be performed by the portal server 12, the application server 25, the client computer 20, the parsing engine 27, or some combination thereof. In some examples, certain steps of FIG. 6 may be performed, for example, in the portal server 12, while other steps may be performed in the application server 25, for example.

In some example, the TNC may include more than one sub-action identifier, sub-application identifier, or other identifier defined in accordance with the set of predefined grammar rules. If one or more portions of the text of the TNC are not successfully parsed according to the method of FIG. 6, then the system may operate according to those portions of the TNC that may have been successfully parsed. As such, the portal server 12 may, for example, send to the portal 22 for display a tile associated with an application program for which the application identifier was successfully parsed, even though other portions of the TNC were not successfully parsed.

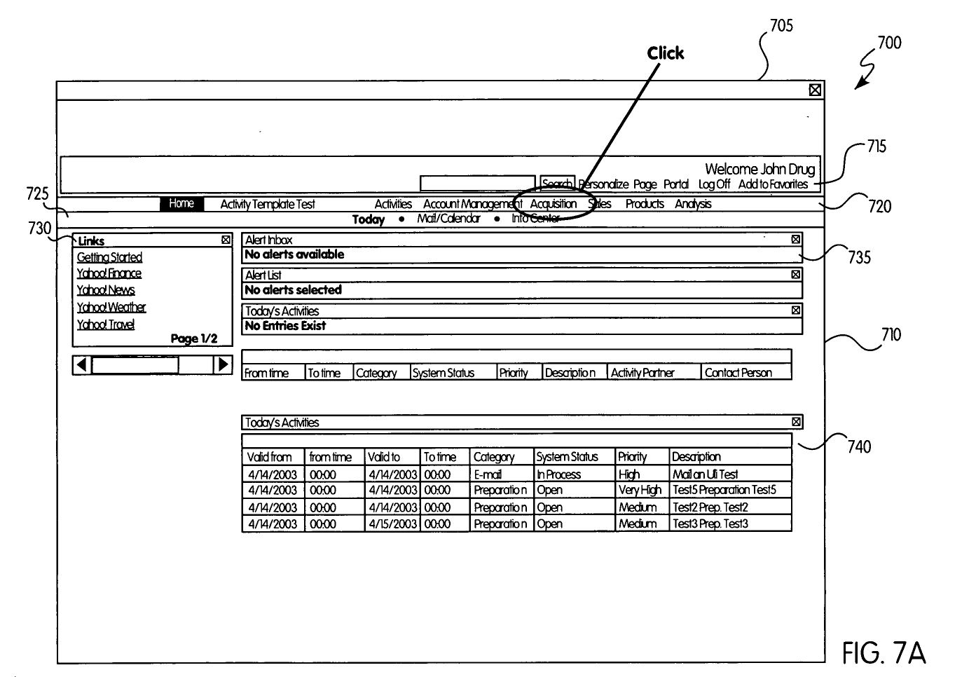

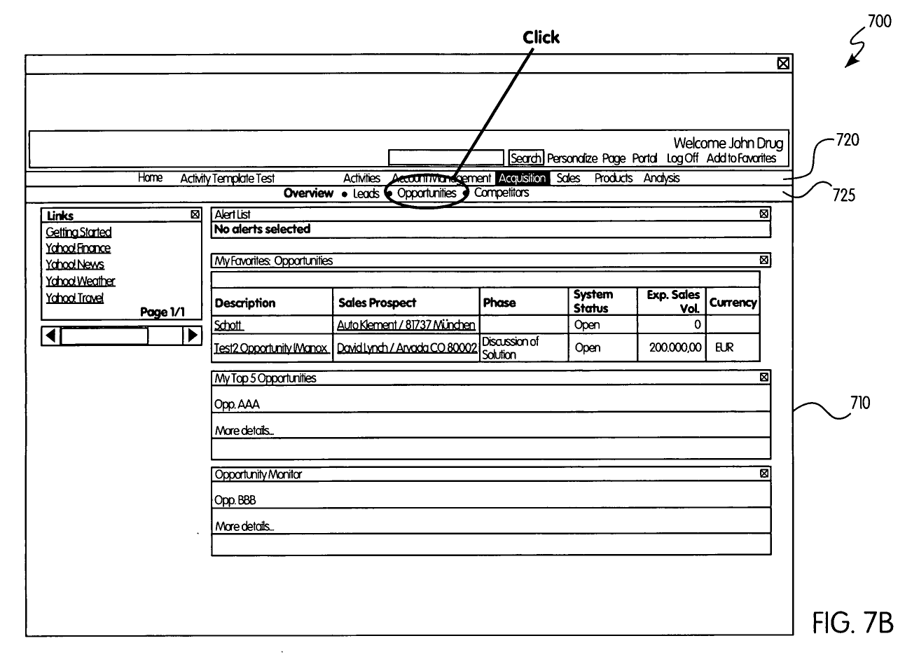

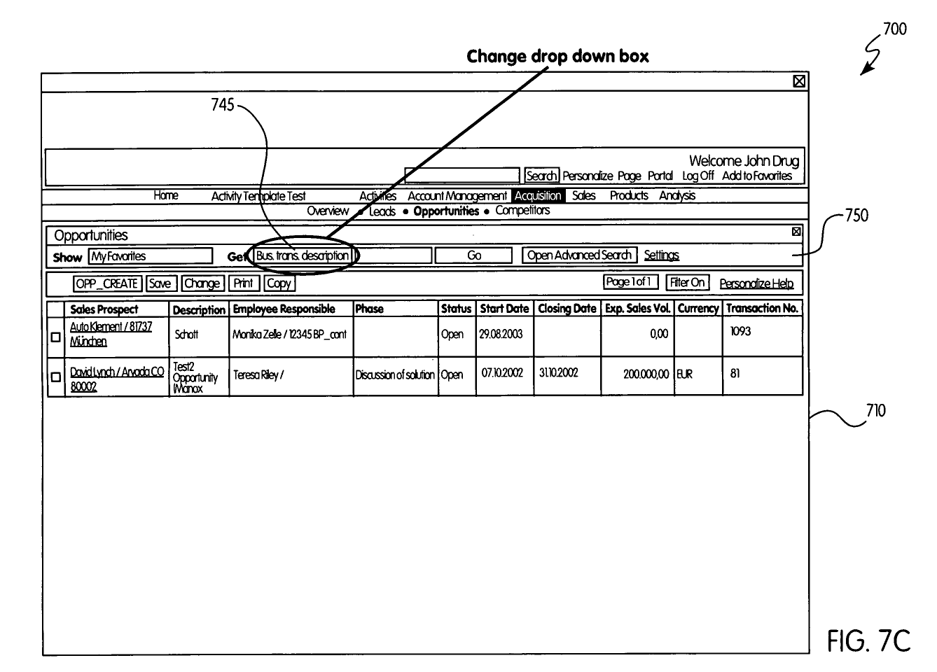

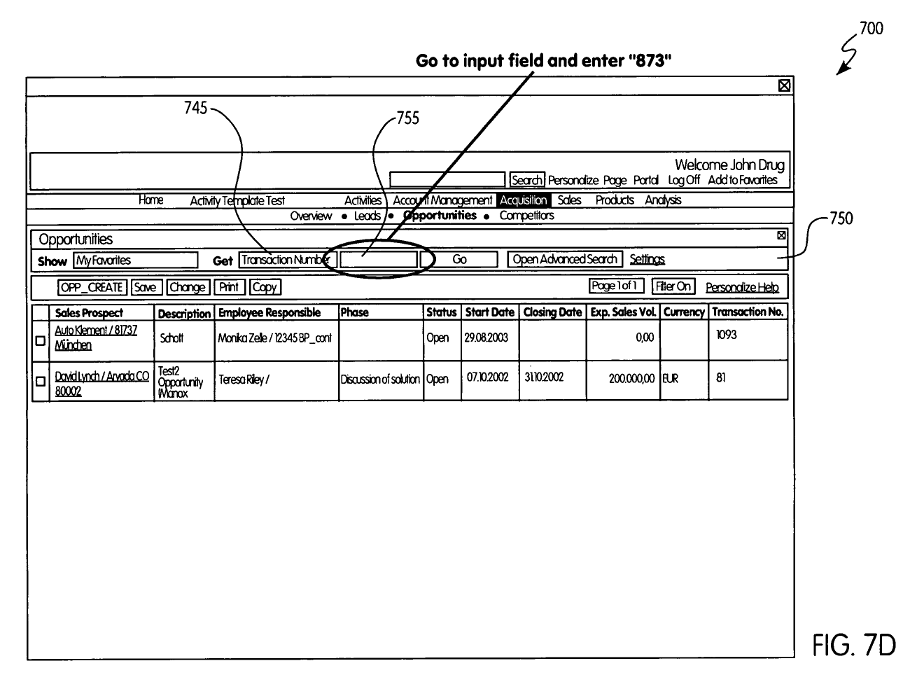

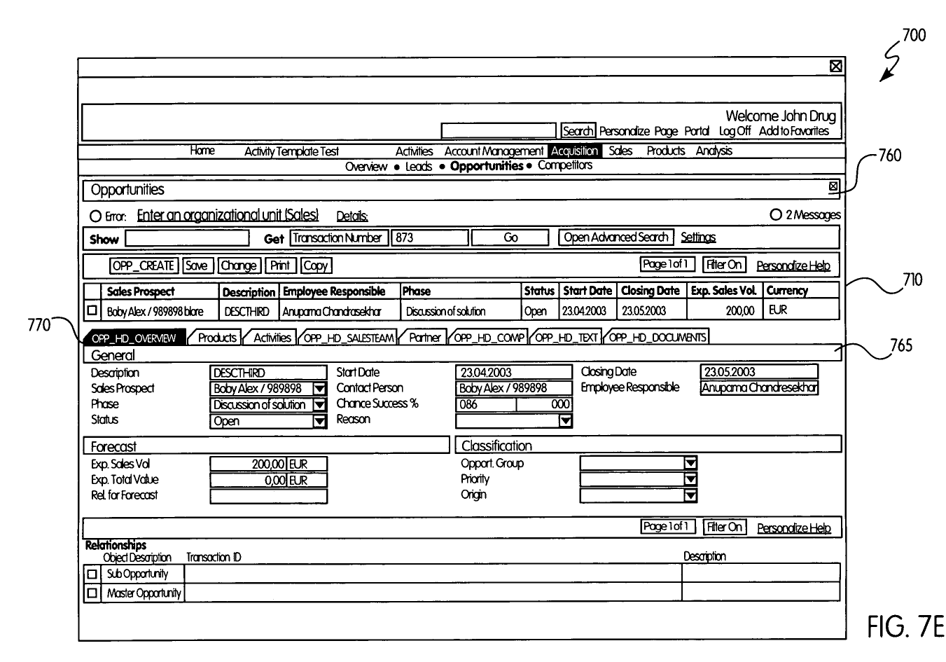

One example of navigation of a hierarchy of tiles displayed in a portal is illustrated in a series of navigation steps in FIGS. 7A-7E. An exemplary portal 700 may be displayed on the display device 19. In this example, the portal 700 is displayed in a browser window 705. The browser window 705 includes controls for operating the browser window. The portal 700 also includes a portal frame 710 that defines a rectangular area in which one or more tiles may be displayed. Along the top border of the portal frame 710 is a reserved area 715. Within the reserved area 715, the portal includes input controls and links for personalizing and operating the portal 705. The reserved area 715 in this example also includes a portal menu bar 720 and a portal sub-menu bar 725. The portal menu bar displays a number of selectable links that a portal user can select by clicking with a mouse-pointing device, for example, in order to navigate to an associated view set. In FIG. 7A, the currently selected view set is the home page as signified by “home” in the portal menu bar 720. In the portal sub-menu bar 725, a number of selectable links are displayed that are associated with the currently selected link in the portal menu bar 720. In this example, the portal sub-menu bar 725 displays three selectable links that are associated with the currently displayed home page in the portal menu bar 720.

Within the portal frame 710, the portal 700 may display one or more tiles that correspond to the currently selected link on the portal menu bar 720 and/or the currently selected link on the portal sub-menu bar 725. The portal 700 may display one or more tiles within the portal frame 710. In this example, the portal 700 currently displays several tiles, including a tile 730 titled “Links,” a tile 735 titled “Alert Inbox”, and a tile 740 titled “My Tasks.”

Next will be described two methods of navigating from the home page being displayed on the portal 700 to a tile associated with the display of information that is generated by accessing an application program. In the first method, conventional portal navigation is used to accessed is an acquisition application program and an associated opportunity sub-application program. According to a conventional method, the user performs a sequence of several input actions to achieve the desired portal display. In the second method, CEPN is used to achieve the desired portal display in a single step. In this example, the desired portal display requires the access of an application/sub-application program and the recall of a particular record, namely transaction number “873.”

FIG. 7A illustrates the portal 700 initially displaying the home page from which the exemplary navigation starts. Using a mouse-pointing device, the user may make a first click on the “Acquisition” link in the portal menu bar 720. In response, the portal 700 is updated to display tiles of information within the portal frame 710 that correspond to predefined display elements associated with the acquisition link, as shown in FIG. 7B. The predefined display elements include an “Opportunities” link on the portal sub-menu bar 725. This “Opportunities” link is associated with the currently selected “Acquisition” link on the portal menu bar 720.

Next, the user clicks on the “Opportunities” link. In response to this second click, the display within the portal frame 710 is updated to correspond to the predefined display associated with the selection of Acquisitions and Opportunities, as shown in FIG. 7C. Within the tile 750 that is displayed, the user further navigates to the desired view set by making a third click to select “Bus.trans.descriptn” from a drop-down list box 745.

The user next proceeds to make a fourth click into an input field 755 that is associated with the drop-down list box 745, as shown in FIG. 7D. Then, in the input field 755, the user enters a desired transaction number. In this example, the user clicks in the input field 755 to select a cursor within the input field 755, and then types in the desired number, which is “873” in this example. Next, the user makes a fifth click select the icon labeled “go” to submit the number in the input field for processing.

The result of the foregoing sequence of clicks and text entry into the portal 700 is shown in FIG. 7E. The portal 700 now displays a desired tile 760 within the portal frame 710. The desired “Opportunities” tile 760 that includes information associated with the application “Acquisition” and the opportunity transaction number “873.”

The display within the portal frame 710 also includes a tile 765 that has associated with it a number of tabs that may be selected to display additional tiles associated with the tile display 760. In this example, a first of the tabs is tab 770, labeled “OPP_HD_OVERVIEW”, displays general information associated with the transaction number 873. Other tabs may be selected to display other information associated with the transaction number 873. The information displayed may be retrieved from a data storage device, such as previously described data storage devices 18, 26, or 72.

The tile 760 may be, in some examples, associated with an application program. In this example, the application program is further associated with a number of tiles, such as tile 770 in this example, for displaying information associated with sub-application programs.

The sequence of steps to navigate from the home page shown in FIG. 7A to the desired display of FIG. 7E, involves a sequence of steps. Specifically, the user performed a click, a second click, a click in a selection from a drop-down list box, a click followed by text entry, and a final click. Moreover, each time the user made an input by selecting a link or entering text information into the computing system, a round-trip may have occurred. A round trip may involve a back and forth cycle involving information being transferred between the client 20, the portal server 12, and in some embodiments, the application server 25. In addition, the portal 700 may be updated to display different tiles and view sets of information within the portal frame 710 with information sent by either the application server 25 or the portal server 12 for display within the portal 700. Information within the portal menu bar 720 and the portal sub-menu bar 725 may be updated by information sent from the portal server 12. In the above-described example, several round trips may have occurred. In a networked computing environment, round trips associated with portal navigation by each of a large number of users can impose a significant computational and data transfer load on the network computing system, such as the work place system 10.

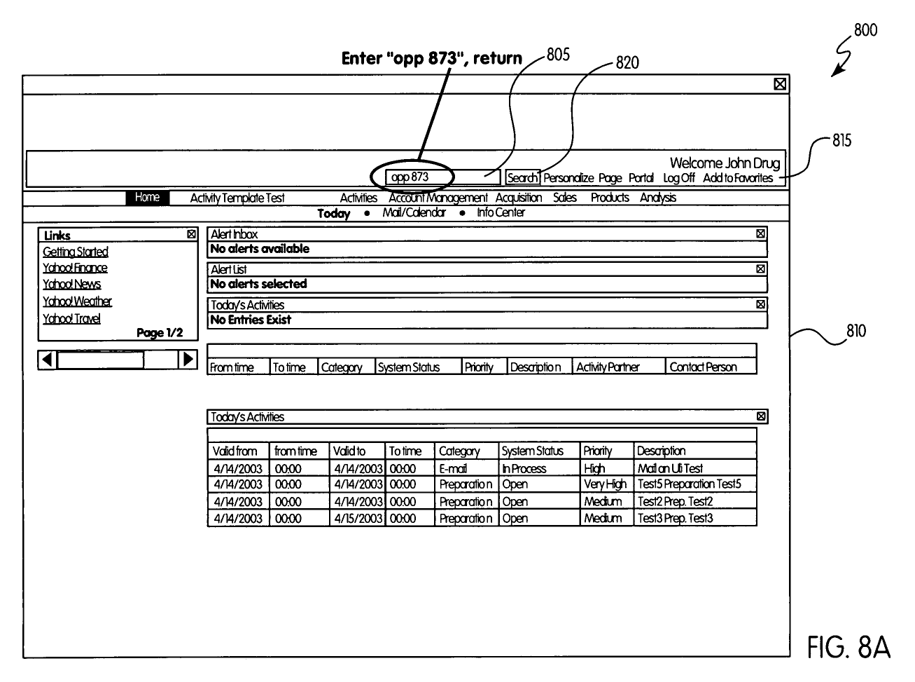

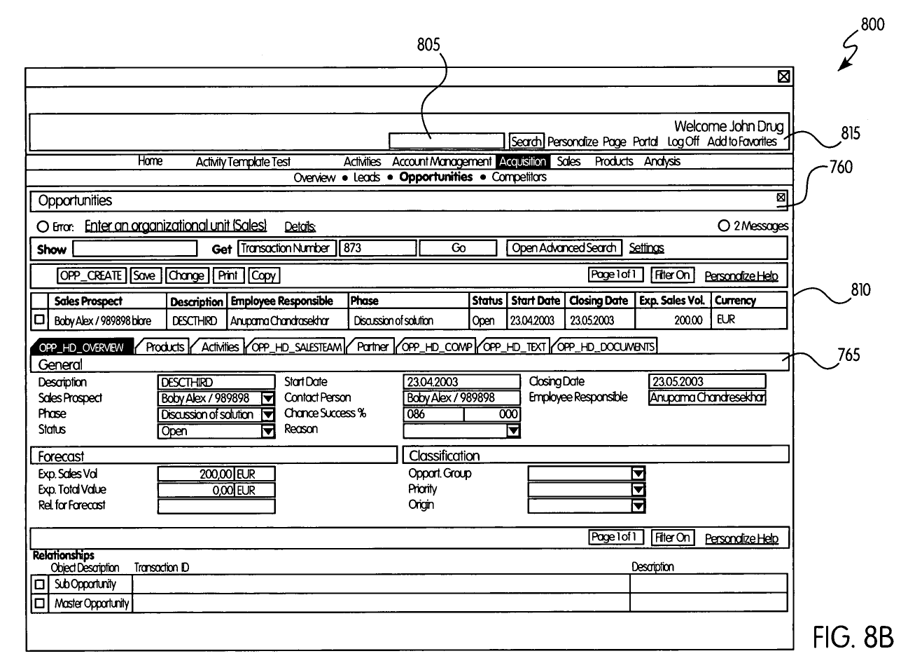

An alternative to the above-described conventional method of portal navigation is CEPN. A user may use CEPN to navigate directly to the desired application tile set. In FIG. 8A, the portal 700 includes an input field 805 in the reserved area 715 of the portal frame. The input field 805 is displayed on the portal frame, specifically in the reserved area 815 of the portal frame 810. The input field 805 may be used to enter search terms that may be input by selecting the search button 820 associated with the input field. However, the input field 805 may also be used to perform direct navigation, and specifically, command entry portal navigation (CEPN).

According to this example, the portal 800 can be used to perform CEPN by the user entering “OPP 873” into the input field 805 and pressing the return key on the keyboard. In response, the portal 800 may display the same result in FIG. 8B as in FIG. 7E. In FIG. 8B, the user has navigated to the “acquisition opportunities” tile 760 and sub-application tile 765, as previously seen using the first described method of FIGS. 7A-7E. Accordingly, a user can use CEPN to achieve, in a single step, the same result as achieved by conventional navigation using a sequence of steps. Using CEPN, the single step involves entering a textual navigation command (TNC) into input field 805. Moreover, the result may be achieved with a single round trip between the client 20, the portal server 12, and the application server 25.

In addition to the foregoing, CEPN may be used to access application programs in other scenarios and examples. In one example, a conventional method of creating an opportunity for a partner “Smith” may conventionally be performed in a portal by performing a sequence of input actions. According to a conventional method, a sequence of input actions may comprise a series of steps, including: (1) clicking on “acquisition” in the menu tool bar of the portal; (2) clicking on the “Opportunities” link; (3) clicking on one of a list of displayed selectable items in the value help pop up window; (4) clicking in a text input field in a tile displaying information associated with the previously selected items; (5) typing into the text input field, for example, the name of a business partner; and, (6) pressing enter to submit the text for processing. A still further step in this example, may involve (7) pressing a function key, for example “F4,” to invoke a form into which the user can enter first and last names into corresponding entry fields. After selecting “enter” to submit the name information, the user finally reaches the desired application and sub-application result.

In an alternative to this first example, the user could have used a CEPN method to directly achieve the application and sub-application result by entering the TNC “create OPP STEG, VOL” into the text input field in the frame of the portal. Accordingly, the CEPN method reduces the number of user input actions required to access the desired application and sub-application. Moreover, the CEPN method may be more intuitive and direct, particularly for experienced users of the application program and the portal.

In another example, CEPN may be used to search for sales orders that contain errors for which a certain person is responsible. In a conventional method, accessing the appropriate application programs to display the desired information on tiles in the portal may require a sequence of steps. The sequence of steps may include, for example, two clicks for portal navigation, pressing a create button, entering the name of a business partner, and invoking a function key “F4” for help locating the records associated with the business partner. In using CEPN, the same result can be achieved in one step by entering “my sales order error” into the text entry field on the portal frame.

In yet another example, CEPN may be used to simplify the access and display of account information for “Smith” who has an address in Washington. Using a conventional method, a sequence of steps may be required to obtain the desired result. In one example, the conventional method includes two clicks for portal navigation, pressing a selectable create button, entering the name of the business partner, and accessing a function key, such as “F4,” for help in identifying the business partner. Using CEPN, the same result can be achieved in one step by entering “partner smith in Wash” into the text entry field on the portal frame.

Interpretation of Textual Navigation Commands

As seen from the above examples, a portal configured to perform CEPN may include a text entry field. A user may perform CEPN by entering a TNC into the text entry field. The TNC determine what tile(s) of displayable information to send to the client device for display on the portal.

To determine how to respond to a TNC, a computing system may parse and interpret the TNC according to predefined grammar rules. A user could enter a command into the text entry field such that, after parsing and interpretation, the TNC is determined to include an application command and an application object (i.e., parameter). The TNC may also include an action command, although some action commands may be defined to be implicit for a particular application. For example, “opp 331” includes an application command (“opp”) and an application object “331,” but it has no specified action identifier. Nevertheless, the grammar may be defined to interpret “opp 331” to invoke the implicit action command to “search” for “opportunity 331.”

When the TNC is parsed, the system identifies the application program. In some examples, the parsing may also further identify, if present, an application identifier, an application object identifier, and an action identifier (which is either directly specified or determined from the grammar).

In addition to reducing the number of mouse clicks required to activate a target application, a TNC may be used to cause substantive actions to be performed that reduce the number of clicks to perform actions within the target application. For example, a TNC “create mail smith” may navigate to and start an email application program, create a new message, and fill in the recipient field (i.e., “To:”) of the message. Specifically, in this example, the TNC “create mail smith” may replace conventional procedures that may use a series of user input actions to: (a) start the email application, (b) create a new message, (c) enter “Smith” in the recipient field, and (d) potentially trigger automatic recognition of “Smith.” Without the use of the TNC to perform CEPN, each of steps (a)-(d) may require one or more user inputs, such as one or more mouse clicks combined with text entry. As such, this is one example of how a TNC may be used to reduce the number of user inputs required to navigate to and to start an application. It also is an example of how a TNC may reduce the number of user input actions required to perform actions within the target application.

Some representative examples of TNC's and their possible effects on the portal display are described in the following table.

| TNC | Description |
|---|---|
| my activities | Display my activities for today |
| new act | Navigate to activity management, create a new |
| | activity (abbreviation of “new activity”) |
| opportunities | navigate to opportunity management, show a list |
| partner smith | of all opportunities with a partner “smith” |
| | involved, eventually restricted by a period |
| opp product | same as above, only list of opportunities with |
| freezer | product freezer |
| opp descr | same as above, only list of opportunities with a |
| NY*night | description starting matching with NY*night |
| calendar dec | show calendar in december |
| opp 345 partn | navigate to opportunity management, show |
| | directly the partners involved in opportunity |
| | 345, i.e. the corresponding partner tab |
| opp ext 444 | same as above, but use the external number |
| product | 444 and go to product tab |
| change partner | navigate to account management, find account |
| smith | “Smith”, open this account in change mode |
| activities | navigate to activity management, show activities |
| overdue one | which were overdue since one month |
| month | |
| partn mil, fr | navigate to account management, find account |
| in wash | “Frank Miller” with address in Washington, |
| | display this account |
| my top 5 oppor | navigate to opportunity management, show the |
| | top 5 opportunities |
| my sales orders | navigate to sales management, find all sales |
| with error | orders having status erroneous |
| salesreport | Report of sales yesterday (alternatives: |
| yesterday | “salesrep yest”, “sales 1.10”, “report october” etc.) |
| open quotation | navigate to analysis, show the analysis of open |
| per region | quotations per region in full screen mode |
| simulate | navigate to analysis, simulate the commission for |
| commission | opportunity 324 |
| opp 324 | |

In the above examples, it may be understood that the TNC may be interpreted according to a set of predefined grammar rules. In some sets of grammar rules, the text of the TNC may be similar to one or more human languages. Some interpreters may interpret according to grammar rules that are similar to a particular human language, for example.

The system may parse the TNC according to the predefined grammar rules to identify terms that may be interpreted. For example, the TNC may be parsed and interpreted in a manner consistent with the examples in the table above. In one embodiment, parsing rules may be established to identify words as separated by blanks. In some examples, blanks may not be required to parse certain predefined reserved words.

After the command has been parsed, the resulting command words may then be interpreted according to the predefined grammar rules. The grammar rules may be used to interpret individual command words in a TNC based on, for example, the position of the word, the context of the application or previous command information, reserved or key words, predefined syntax, or a combination of all of these elements. Other factors may also be considered. For examples, abbreviations and synonyms (e.g. “opp”, “oppor”, “opportunities”, or “opportunity”) may be allowed to simplify the command entry for users. Actions and business applications may have unique identifiers under some grammar rules. In some examples, multiple sub-identifiers may allow blanks between identifiers (e.g., sales order). Not all identifiers need to be fully specified if they are uniquely identified. For example, “part Miller,” “pa*er Miller,” and “partner Miller” may all be interpreted as the same command. Accordingly, grammar definitions may be flexible. For example, both “create sales order” or “order sales create” may be valid TNC's.

Words that are not identified as either application or action identifier(s) according to predefined grammar rules may be interpreted, for example, as application object identifiers (e.g., “Miller”). The application object identifier may be executed by the application itself according to rules specific to the application. For example, to find a business partner, a user may enter a TNC such as “partner Miller, Fr management.” That TNC may identify the business partner and cause records associated with “Frank Miller” to be displayed on a tile in the portal. In this example, the two words “Miller”, and “Fr” may be interpreted by the application server as ([last name], [first name]) according to the syntax of the application program “account management” rather than by the portal server according to generic portal grammar rules. In one embodiment of this example, the application program may be called before portal navigation is performed. According to that embodiment, the application object identifier may influence the resulting portal navigation by determining what information the application server sends to the portal server for display in response to the TNC.

A number of embodiments have been described. Nevertheless, it will be understood that various modifications may be made without departing from the spirit and scope of the invention. For example, various devices and methods may be used to enter text to provide a textual navigation command (TNC). Examples of text input devices may include keyboards, voice recording equipment with voice recognition software that converts speech to written text, touch screens, hand held or portable computing devices, PDAs, text-capable telecommunication devices, scanners with optical character recognition (OCR), screen-displayed keyboards with keys that may be selected using a mouse-pointing device, and the like.

Some embodiments may use CEPN to access either or both application programs that are commercially available as software packages, or they may include customized application programs. The commands could be used in a portal via a web-based browser. The application programs may be stored on one or more data storage devices associated with one or more application servers. The application servers may or may not be combined with one or more portal servers. In some embodiments, the portal server and application server may be included in a single computer that has a main processor and a data storage device. In some embodiments, the application programs and web-based portal may be stored on one or more data storage devices, such as a RAID system.

In various embodiments, command entry navigation may be used for commercial or non-commercial (e.g., educational, personal, home office) purposes to improve the efficiency and productivity with which application programs may be used. In various implementations, the computing system may or may not be networked with other computers, clients, servers, whether over WANs, LANS, wireless networks, or the Internet.

Each computer program may be stored on a storage medium (e.g., CD-ROM, hard disk, volatile memory, nonvolatile memory, or magnetic or optical diskette) that is readable by a general or special purpose programmable computer for configuring and operating the computer when the storage medium or device is read by the computer to perform applications.

As used herein, the term “computer system” refers to a physical machine having one or more processing elements and one or more storage elements in communication with the one or more of the processing elements. Each of the various user devices and computers described herein include an operating system. The operating system is software that controls the computer system's operation and the allocation of resources. The term “process” or “program” refers to software, for example an application program that may be executed on a computer system. The application program is the set of executable instructions that performs a task desired by the user, using computer resources made available through the operating system.

A user may interact with a personal computer or wireless device (a “user device”) to send and receive messages and data from a computer network. Typically, the user device includes a visual display device for displaying text and images, and a graphical user interface (GUI) to allow the user to interact with an operating system running on the user device. Many GUI's cause the display of a “desktop” on the display device, i.e., where the desktop refers to a graphical work surface analogous to a surface of a desk. Typically, the desktop displays icons representing programs, files, and resources available to the user. As such, the desktop acts as a launching point for running application programs, opening documents or files, displaying menus, and initiating operating system services.

The GUI may also use a windowing environment that presents the user with specially delineated areas called windows on the display device, each of which is dedicated to a particular application program, file or document. Windows that overlay the desktop in the GUI are analogous to papers or files lying on top of the desk. Typically, the windows may be re-sized, moved around on the display, and stacked so as to overlay other windows. The windowing environment may also allow windows to be increased to a full-screen display or minimized, meaning the window is reduced to and denoted by an icon.

A typical display window includes one or more “active” regions or icons. The active regions are associated with instructions to be executed upon the occurrence of an action by the user to select the active region (e.g., a mouse “click” on an active area). For example, instructions associated with an active region may cause a jump to a specified location upon the occurrence of a mouse-click within the active region. Other events can also cause the execution of instructions. In particular, a detected movement of a mouse and/or an entry of a mouse pointer into an active region (in either case, with or without a click of a mouse button) are also events that may be used to trigger the execution of instructions associated with that region.

The systems and techniques described here need not be limited to the specific details described above. For example, stored data may represent addresses or “links” to other data or addresses stored on workplace system 10, or external to system 10. The data storage devices 18 and 25 may be separate data storage devices, or they may be integrated into a single storage medium. The portal server 12, the application server 25, the parsing engine 27, and the client device 20, for example, may be implemented as applications running on a single host computer, such as a personal computer.

In some embodiments, the parsing engine 27 may be implemented in the portal server 12, the application server 25, the client device 20, or in a combination of these components. One of ordinary skill in the art will recognize the corresponding need to modify the exchange of parsed information between these components to reflect the implementation of the parsing engine 27 and the implementation of the aforementioned components.

According to an embodiment, a user may want to successively create an appointment, an email, and a meeting request. Using CEPN, the user can successively navigate to each application by entering three TNC's to activate each application in turn. In this case, the user may avoid using the mouse one or more times in order to perform these successive tasks.

In one example, the portal may provide a text entry field into which a user may type in, for example, (1) “create sales order”, (2) “partner miller”, or (3) “activity 2354.” By entering these TNC's, the user may perform CEPN. In these examples, (1) the new sales order is accessed and displayed for input; (2) all information for business partner Miller is displayed; or (3) the activity 2354 is accessed for review or editing. These examples illustrate that CEPN may include navigating directly to the target application tile(s), or sub-application tiles. Moreover, any objects, modes, or action commands included in the TNC may be also be acted on appropriately, according to their interpretation under the predefined grammar or the associated application programs.

Accordingly, other embodiments are within the scope of the following claims.

What is claimed is:

1. A method of accessing one of a plurality of application programs, wherein accessing any of the application programs causes a tile of displayable information to be generated for display within the frame of a portal that is being displayed on a display device, the method comprising:
receiving a user-input textual navigation command (TNC) that is associated with an input field being displayed on the frame of the portal, the TNC comprising a command that identifies one of a plurality of application programs to be accessed;
identifying the application program to be accessed;
accessing the identified application program;
generating a tile of displayable information associated with the accessed application program; and
sending the generated tile to be displayed within the frame of the portal.

2. The method of claim 1 wherein the input field is persistently displayed in a reserved area on the frame of the portal.

3. The method of claim 1, wherein the received TNC is determined from a signal 2 generated by operation of a text entry device.

4. A method of accessing one of a plurality of application programs, wherein 2 accessing any of the application programs causes a tile of displayable information to be generated for display within the frame of a portal that is being displayed on a display device, the method comprising:
receiving a user-input textual navigation command (TNC) that is associated with an input field being displayed on the frame of the portal, the TNC comprising:
a command that identifies one of a plurality of application programs to be accessed; and
a command that identifies an action to be performed;
identifying the application program to be accessed;
accessing the identified application program;
identifying the action to be performed;
performing the identified action within the accessed program;
generating a tile of displayable information associated with the accessed application program and the performed action; and
sending the generated tile to be displayed within the frame of the portal.

5. The method of claim 4, wherein the performed action comprises accessing information stored in a data storage device.

6. The method of claim 4, wherein identifying the application program to be accessed comprises interpreting the received TNC according to a set of predefined grammar rules.

7. The method of claim 6, wherein interpreting the received TNC according to a set of predefined grammar rules comprises executing instructions on a portal server to identify the application program to be accessed, wherein the portal server is configured to send information to the display device to display the portal framework.

8. The method of claim 7, further comprising sending information associated with the command that identifies the action to be performed from the portal server to an application server.

9. The method of claim 8, wherein the application server executes a set of programmed instructions to perform the identified action within the accessed application program.

10. The method of claim 4, wherein the TNC further comprises a sub-application command that identifies which of a plurality of predefined sub-applications is to be accessed.

11. The method of claim 4, wherein the TNC further comprises an application object command that defines information that is to be processed by the accessed application program.

12. The method of claim 4, wherein the TNC further comprises a sub-action command that defines which of a plurality of predefined actions is to be performed in the accessed application program.

13. The method of claim 4, wherein the TNC further comprises a plurality of sub-action commands that define a set of actions to be performed in the accessed application program.

14. The method of claim 8, further comprising performing the action in the set of actions in a sequence according to the set of predefined grammar rules.

15. The method of claim 4, wherein the identified action comprises a member of the group consisting of: display, create, new, and change.

16. The method of claim 4, wherein the received TNC is determined from a signal generated by operation of a text entry device.

17. The method of claim 4, wherein the input field is persistently displayed in a reserved area on the frame of the portal.

18. A computer program product tangibly embodied in an information carrier, the computer program product containing instructions that, when executed, cause a processor to perform operations to access one of a plurality of application programs, wherein accessing any of the application programs causes a tile of displayable information to be generated for display within the frame of a portal that is being displayed on a display device, the operations comprising:
receive a user-input textual navigation command (TNC) that is associated with an input field being displayed on the frame of the portal, the TNC comprising a command that identifies one of a plurality of application programs to be accessed;
identify the application program to be accessed;
access the identified application program;
generate a tile of displayable information; and
send the generated tile to be displayed within the frame of the portal.

19. The computer program product of claim 18, wherein the TNC further comprises a command that identifies an action to be performed, and the operations further comprise:
identify the action to be performed; and
perform the identified action within the accessed program, wherein the generated tile includes displayable information associated with the performed action.

20. The computer program product of claim 18 wherein the input field is persistently displayed in a reserved area on the frame of the portal.
